(19) United States
(12) Patent Application Publication
(10) Pub. No.: US 2019/0202339 A1
(43) Pub. Date: Jul. 4, 2019

(54) METHOD OF ADJUSTING MOTOR VEHICLE HEADLIGHTS FOR ROAD TOPOGRAPHY

(71) Applicant: FORD GLOBAL TECHNOLOGIES, LLC, Dearborn, MI (US)

(72) Inventors: Gregor ALLEXI, Troisdorf NRW (DE); Gerald DOERNE, Cologne NRW (DE)

(73) Assignee: FORD GLOBAL TECHNOLOGIES, LLC, Dearborn, MI (US)

(21) Appl. No.: 16/224,926

(22) Filed: Dec. 19, 2018

(30) Foreign Application Priority Data
Jan. 2, 2018 (DE) 10 2018 200 005.0

(51) Int. Cl. B60Q 1/08

(52) U.S. Cl. CPC B60Q 1/085; B60Q 2300/41; B60Q 2300/112; B60Q 2300/132; B60Q 2300/054; B60Q 2300/324

(57) ABSTRACT

A method for adjusting a distribution of light from a headlight of a first motor vehicle in order to avoid the headlight blinding of dazzling a driver of a leading vehicle travelling ahead of and in the same direction as the first vehicle. The method includes: detecting a following distance between the vehicle and the leading vehicle on an initial road section; operating the headlight at a first illumination range less than or equal to the following distance; detecting a directionally-deviating road section ahead of and having a direction different from the initial road section; detecting that the leading vehicle has moved beyond a transition between the initial road section and the directionally-deviating road section; operating the headlight at a second illumination range not extending beyond the transition; and operating the headlight at the first illumination range after the vehicle reaches the transition.

### CROSS-REFERENCE TO RELATED APPLICATIONS

This application claims foreign priority benefits under 35 U.S.C. § 119(a)-(d) to DE Application 10 2018 200 005.0 filed Jan. 2, 2018, which is hereby incorporated by reference in its entirety.

### TECHNICAL FIELD

The present invention relates to a method for adjusting a distribution of light of a headlight of a motor vehicle.

### BACKGROUND

The distribution of light of a headlight (sometimes also referred to as a headlight's beam-pattern) is commonly divided between a normal or “dipped” setting at which the maximum illumination range of the headlight is set to a relatively shorter distance (in order to avoid blinding or dazzling drivers of oncoming vehicles) and a “high beam” setting at which the maximum illumination range is set to a relatively longer distance when oncoming traffic is of no concern. In a planar landscape with long curves the dipped beam typically does not lead to the oncoming traffic becoming dazzled. However, it may be necessary to accordingly adjust the high beam to a shorter illumination range according to the vehicles traveling ahead and the oncoming traffic.

An adjustment of the distribution of light of the headlight may be performed by way of example by means of using screens in front of the light source of the headlight as taught by U.S. Pat. No. 7,364,333 B2. In so doing, individual sections may be blocked in the distribution of light of the headlight. One example of such an adjustment is disclosed in DE 10 2009 054 249 A1. In addition to using screens in front of the light source of the headlight, the whole headlight may also be tilted in accordance with DE 10 2009 045 321 A1. In this case, the light cone of the headlight is tilted down onto the road with the result that the driver of the oncoming vehicle is not dazzled. Another possibility of adjusting the distribution of light of the headlight is disclosed in U.S. Pat. No. 8,120,652 B2, wherein the headlight comprises a matrix of LED lamps that may be switched on or switched off individually or in groups according to the traffic situation.

Along stretches or portions of roadway over which the incline varies or changes, situations may occur in which the dipped light (in addition to the high beam) contributes to dazzling the driver of the oncoming vehicle. In order to detect changes in inclines in the course of the road ahead of the motor vehicle before such a dazzling occurs, a method is disclosed in U.S. Pat. No. 6,990,397 B2 that identifies a change in the incline by means of an artificial horizon in a recorded camera image. The change in the incline could indicate by way of example a hilltop. The distribution of light may then be limited in such a manner that the region above the hilltop is not illuminated. A headlight apparatus for such a situation is disclosed in U.S. Pat. No. 6,960,005 B2. In addition to directly detecting a change in incline of a road that extends ahead of a motor vehicle, as mentioned by way of example a hilltop, such a change in topography may also be transmitted by means of a data transmission system to the motor vehicle. A data transmission from motor vehicle to motor vehicle or a data transmission from the traffic management system to the motor vehicle is disclosed in U.S. Pat. No. 9,555,736 B2.

The purpose of adjusting the distribution of light of a headlight is not limited to preventing only a driver of an oncoming motor vehicle from being dazzled, but rather may also provide the benefit of preventing a driver of a vehicle that is travelling ahead of and in the same direction as the headlight-equipped vehicle (referred to herein as a leading vehicle) from being dazzled, said driver being impaired as a result of being dazzled owing to the rear-view mirror. A method for circumventing such a dazzling event is disclosed in US 2016/0034770 A1.

The present invention provides a method that prevents the driver of a leading vehicle that is traveling ahead from becoming dazzled when said motor vehicle has just passed a hilltop.

### SUMMARY

The method disclosed herein provides a method for adjusting a distribution of light from a headlight of a first motor vehicle. The method comprises the steps of:

detecting a leading vehicle travelling on the same road as the first motor vehicle and ahead of the first motor vehicle,

illuminating the stretch of road between the first motor vehicle and the leading vehicle,

storing the length of this stretch of road between the first motor vehicle and the leading vehicle,

detecting a road section that extends ahead of the first motor vehicle and that changes the direction of the road,

reducing the illumination if the first motor vehicle is approaching the road section that changes the direction of the road with the result that the region above this road section is not illuminated,

detecting that the road section that changes the direction of the road has been passed by the leading vehicle, wherein when passing the road section the leading vehicle moves out of the detection zone of the first motor vehicle,

detecting that the road section that changes the direction of the road has been passed by the first motor vehicle,

calling up the stored stretch of road length that was previously determined between the first motor vehicle and the leading vehicle,

illuminating a stretch of road ahead of the first motor vehicle, wherein the length of the illuminated stretch of road corresponds to the stretch of road length of every previously determined and stored stretch of road between the first motor vehicle and the leading vehicle.

Dazzling of a leading vehicle (defined herein as a vehicle traveling ahead of and in the same direction as the vehicle practicing the disclosed method) is avoided by an adjustment in a distribution of light (more specifically, a limitation or reduction of the maximum illumination distance) of a headlight of the following motor vehicle. The reduced maximum illumination distance is maintained for as long as the leading vehicle is located within the detection zone of the following motor vehicle. However, if the leading vehicle travels or drives onto a road section that deviates from the direction of travel of the initial road section, the leading vehicle thus travels out of the detecting range of the following motor vehicle. The following motor vehicle may then increase the maximum illumination range to exceed that set in the previously provided adjustment to illuminate as great a distance the road as is feasible without any possibility of dazzling the driver of the leading vehicle. However, as soon as the following motor vehicle also reaches this directionally-deviating road section, the leading vehicle may again be within the detection zone of the following motor vehicle. It is herein possible for the driver of the leading vehicle to be dazzled via the mirror as a result of the following motor vehicle. The present method prevents this situation in that the distance between the leading vehicle and the following motor vehicle is stored as the stretch of road having a length that is the same as the following distance and as soon as the following motor vehicle passes the road section that changes the direction of the road, the illumination range of the light distribution is reduced so that only the length of the stored stretch of road is illuminated. This helps to avoid dazzling the driver of the leading vehicle.

In accordance with further embodiments, the directionally-deviating road section may be a curve (the directional deviation is in a horizontal plane) or a hilltop (the directional deviation is in a vertical plane).

The hilltop may be detected in different ways. In accordance with one embodiment disclosed herein, the hilltop may be detected via determining an incline of a road section on which the motor vehicle is currently travelling and an incline of a road section ahead of the motor vehicle.

In accordance with a further disclosed embodiment, the directionally-deviating road section may be detected with the aid of topographical information. This topographical information may, in one embodiment, be transmitted by at least one further motor vehicle to the first motor vehicle. In accordance with a further embodiment, this topographical information may be transmitted from a traffic management system to the first motor vehicle. A directionally-deviating road section ahead of the first motor vehicle may consequently be detected by means of different methods. Alternatively, further detecting systems may also be used, such as for example image recognition systems used on images that are recorded in the direction of travel.

The first motor vehicle comprises in accordance with a further embodiment at least two wheels. In accordance with the same embodiment, the leading vehicle may also comprise at least two wheels. It is preferred that the method is designed for a first motor vehicle having four wheels.

Further features, characteristics and advantages of the present invention are apparent in the exemplary embodiment below with reference to the attached figures.

### BRIEF DESCRIPTION OF THE DRAWINGS

FIG. 1 illustrates a stretch of road having two motor vehicles shortly prior to traversing a hilltop; and

FIG. 2 illustrates a flow diagram describing a method disclosed herein.

### DETAILED DESCRIPTION

An exemplary embodiment is described below with reference to the figures for adjusting a distribution of light of a headlight 3 of a first motor vehicle 1 in such a manner that a leading motor vehicle 2 (traveling ahead of and in the same direction as the first motor vehicle) is not dazzled by the light distribution 12 of the headlight 3.

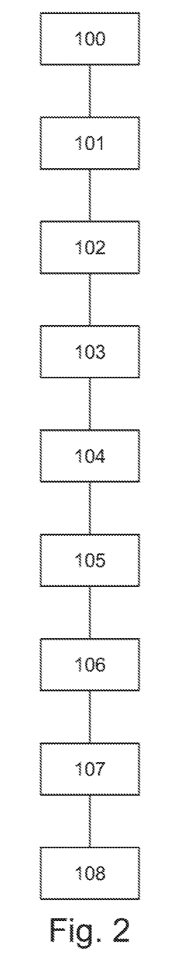

FIG. 2 illustrates a flow diagram that illustrates the method in accordance with the invention of a distribution of light of a headlight 3 of a first motor vehicle 1. In the present exemplary embodiment, the road section that changes the direction of the road (referred to as the directionally-deviating section) is a hilltop 11. The present invention involves the steps of determining and storing the length 13 of the stretch of road between the leading vehicle 2 and the following motor vehicle 1 (also referred to as the following distance), passing of the hilltop 11 first by the leading vehicle 2 and subsequently by the following motor vehicle 1, and illuminating the road after the two motor vehicles 1, 2 have traversed the hilltop 11 in such a manner that the leading vehicle 2 is not dazzled.

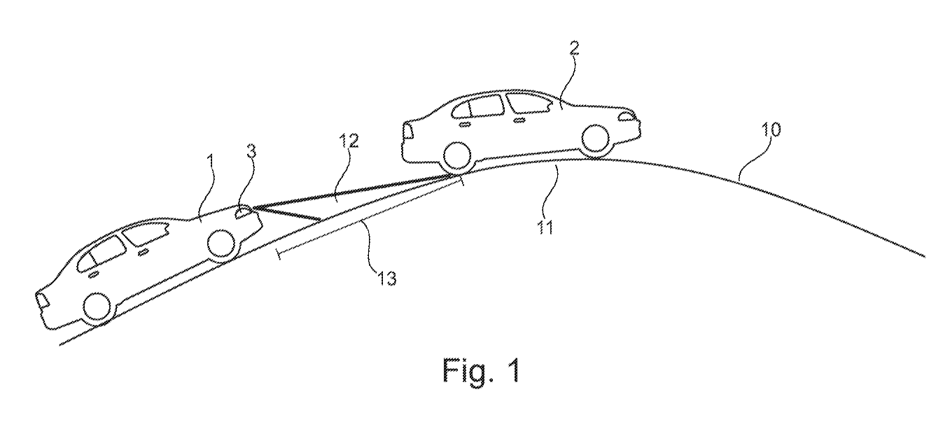

FIG. 1 illustrates a stretch of road 10 including a crest or hilltop 11. Two motor vehicles 1, 2 are located on the road 10 shortly prior to traversing the hilltop 11. The following motor vehicle 1 detects the leading vehicle 2, (FIG. 2, step 100). The leading vehicle 2 and the following motor vehicle 1 are separated by a following distance 13. The headlight 3 of the vehicle 1 is operated so as to project a light distribution 12 having a maximum range limited to illuminate a stretch of road that does not extend beyond the following distance 13 (FIG. 2, step 101). The driver of the leading vehicle 2 is, as a consequence, not dazzled by the light distribution 12 of the headlamp 3 being visible in a rear-view mirror. The following distance 13 is stored in the following motor vehicle 1 (FIG. 2, step 102). The road beyond the stretch of road equal to distance 13 must not be illuminated so that the leading vehicle 2 is not dazzled.

The following motor vehicle 1 detects the hilltop 11 in the road ahead, (FIG. 2, step 103). The leading vehicle 2 now passes beyond or over the hilltop 11 and due to passing beyond the crest of the hilltop moves out of the detection range or zone of the following motor vehicle 1 (FIG. 2, step 104). The following motor vehicle 1 is therefore no longer able to detect the leading vehicle 2 using its on-board sensor system. The following motor vehicle 1 now only detects the hilltop 11. When the following motor vehicle 1 is approaching the hilltop 11, the illumination distance of the road 10 provided by the headlight 3 is reduced in such a manner that the region above the hilltop 11 is not illuminated (FIG. 2, step 105). This means that the distribution of light of the headlight 3 illuminates only the portion of the road 10 between the following motor vehicle 1 and the start or peak of the hilltop 11. The maximum illumination range provided by the headlight 3 is adjusted such that the upper limit of the light pattern it does extend beyond the crest or apex of the hilltop. Light that would otherwise have passed above the hilltop 11 may be shielded by way of example by means of screens in the headlight 3 which limit the upper edge of the light beam. Alternatively, it is also possible to tilt the headlight 3 in the direction of the road 10 with the result that the upper edge or limit of the light beam from the headlight 3 does not illuminate the region above the hilltop 11. The illumination between the following motor vehicle 1 and the crest of the hilltop 11 is therefore adjusted in a dynamic manner as the vehicle 1 approaches the hilltop. The closer the following motor vehicle 1 comes to the crest of the hilltop 11, the more intense the reduction in the illumination. As soon as the following motor vehicle 1 passes the hilltop 11 (FIG. 2, step 106), the illumination range ahead of the following motor vehicle 1 increases.

In accordance with the disclosed method, the illumination distance of the roadway ahead of the following motor vehicle 1 is limited. In contrast with conventional methods, in this case the road 10 ahead of the following motor vehicle 1 is not illuminated to its maximum extent. As soon as the following motor vehicle 1 has passed the hilltop 11, there is a particularly high probability that the leading vehicle 2 will reenter the detection range or zone of the following motor vehicle 1. In order to prevent the leading vehicle 2 from becoming dazzled, the stretch of road ahead of the following motor vehicle 1 is illuminated only to a range which corresponds to the previously determined following distance 13 (FIG. 2, step 108). As described above, the illuminated road length 13 corresponds to the following distance between the leading vehicle 2 and the following motor vehicle 1. For this purpose, after the following motor vehicle 1 has passed the crest of the hilltop 11, the stretch of road length 13 is called up (FIG. 2, step 107), wherein the following motor vehicle 1 consequently only illuminates to the maximum extent the stretch of road having the stretch of road length 13. A leading vehicle 2 is therefore not dazzled, even if the leading vehicle 2 has temporarily moved out of the detecting range or zone of the following motor vehicle 1 as a result of traversing the hilltop 11.

A hilltop 11 in the road ahead 10 may be determined via an incline of a road section below the first motor vehicle 1 and via an incline of a road section far ahead of the first motor vehicle 1. A hilltop 11 that is present in the road ahead 10 of the first motor vehicle 1 is detected by means of comparing the two inclines. However, the hilltop may also be detected with the aid of topographical information. This topographical information may on the one hand be transmitted by at least one further motor vehicle to the first motor vehicle 1 or said topographical information may be transmitted with the aid of a traffic management system from said motor vehicle to the first motor vehicle 1. Alternatively, the information regarding a presence of a hilltop 11 may also be transmitted to the first motor vehicle 1 both by multiple motor vehicles as well as in conjunction with a traffic management system. As a further alternative, it is possible that the hilltop is detected by means of a camera system and image evaluating software.

The first motor vehicle 1 comprises at least two wheels. It is preferred that the method in accordance with the invention may be used in a first motor vehicle 1 having four wheels. The leading vehicle 2 comprises at least two wheels and is preferably a motor vehicle having four wheels. The leading vehicle 2 may consequently be a motor vehicle having two wheels, such as by way of example a motorbike, or alternatively may be a motor vehicle having more than four wheels, such as by way of example a passenger car or a truck.

The present invention has been described in detail with reference to an exemplary embodiment for explanatory purposes. However, a person skilled in the art recognizes that deviations from the exemplary embodiment are possible. By way of example, the method may be used on other motor vehicles that by way of example drive on field paths and are not actively involved in traffic. The invention is therefore not to be limited to the exemplary embodiment but rather is only to be limited by means of the attached claims.

What is claimed is:

1. A method for controlling a headlight of a vehicle, comprising:
detecting a following distance between the vehicle and a leading vehicle traveling ahead of the vehicle on an initial road section;
operating the headlight at a first illumination range less than or equal to the following distance;
detecting a directionally-deviating road section ahead of and having a direction different from the initial road section;
detecting that the leading vehicle has moved beyond a transition between the initial road section and the directionally-deviating road section;
operating the headlight at a second illumination range not extending beyond the transition; and
operating the headlight at the first illumination range after the vehicle reaches the transition.

2. The method of claim 1, wherein the direction of the directionally-deviate road section deviates from the initial road section in a vertical plane and corresponds to a hilltop.

3. The method of claim 2, wherein the hilltop is detected by determining an incline of the initial road section and an incline of a road section ahead of the vehicle.

4. The method of claim 1, wherein the directionally-deviating road section is detected using topographical information.

5. The method of claim 4, wherein at least a portion of the topographical information is transmitted to the vehicle from the leading vehicle.

6. The method of claim 4, wherein at least a portion of the topographical information is transmitted to the vehicle from a traffic management system.

7. A method for controlling a headlight of a vehicle, comprising:
detecting a following distance between the vehicle and a leading vehicle traveling ahead on an initial road section;
setting a headlight maximum illumination range to the following distance;
detecting that the leading vehicle has moved onto a directionally-deviating road section ahead of the initial road section;
setting the headlight maximum illumination range to short of a start of the directionally-deviating road section;
detecting that the vehicle has reached the start; and
setting a headlight maximum illumination range to the following distance.

8. The method of claim 7, wherein the directionally-deviating road section changes direction from the initial road section in a vertical plane, and the start corresponds to a hilltop.

9. The method of claim 8, wherein the hilltop is detected by determining an incline of the initial road section and an incline of a road section ahead of the vehicle.

10. The method of claim 7, wherein the directionally-deviating road section is detected using topographical information.

11. The method of claim 10, wherein at least a portion of the topographical information is transmitted to the vehicle from the leading vehicle.

12. The method of claim 10, wherein at least a portion of the topographical information is transmitted to the vehicle from a traffic management system.

13. A method comprising:
detecting a following distance between a vehicle having a headlight and a leading vehicle traveling on a road section;
setting a headlight illumination range to the following distance;
detecting that the leading vehicle has moved onto a directionally-deviating road section;
setting the illumination range to short of a start of the directionally-deviating road section;
detecting the vehicle reaching the start; and
setting the illumination range to the following distance.

14. The method of claim 13, wherein the directionally-deviating road section changes direction in a vertical plane, and the start corresponds to a hilltop.

15. The method of claim 14, wherein the hilltop is detected by determining an incline of the road section and an incline of a road section ahead of the vehicle.

16. The method of claim 13, wherein the directionally-deviating road section is detected using topographical information.

17. The method of claim 16, wherein at least a portion of the topographical information is transmitted to the vehicle from the leading vehicle.

18. The method of claim 16, wherein at least a portion of the topographical information is transmitted to the vehicle from a traffic management system.
